(19) United States
(12) Patent Application Publication
(10) Pub. No.: US 2026/0317629 A1
(43) Pub. Date: Oct. 15, 2026

(54) CONTROLLING INDUSTRIAL OVENS IN REAL-TIME ACCORDING TO COMPUTER-RECOGNIZED EMISSIONS DEGREES

(71) Applicants: PAUL WURTH S.A., Luxembourg (LU); PAUL WURTH ITALIA S.P.A., Genova (IT)

(72) Inventors: Alberto VICENTINI, Genoa (IT); Cédric SCHOCKAERT, Wiltz (LU)

(21) Appl. No.: 19/485,557

(22) PCT Filed: May 23, 2024
(86) PCT No.: PCT/EP2024/064258

§ 371 Date: Nov. 18, 2025

(30) Foreign Application Priority Data
May 23, 2023 (LU) LU504290

(51) Int. Cl. C10B 41/08; G06T 7/00

(52) U.S. Cl. CPC C10B 41/08; G06T 7/0004

(57) ABSTRACT

A computer obtains a pressure set-point for a programmable controller that is associated with an oven and that controls the gas pressure inside the oven. The controller receives pressure data from a pressure sensor and interacts with a pressure valve. From a camera that is located external to the oven, the computer obtains a leakage-area image that shows an area of the external surface of the oven where gas emissions can be present. The computer processes the image by a pre-trained network to classify a degree of emissions. By applying pre-defined rules, and depending on the classified degree, the computer changes the set-point (p_set) for the programmable controller.

CROSS-REFERENCE TO RELATED APPLICATIONS This application is a 35 U.S.C. § 371 National Stage patent application of no. PCT/EP2024/064258, filed on 23 May 2024, which claims the benefit of Luxembourg patent application no. LU504290, filed 23 May 2023, the disclosures of which are incorporated herein by reference in their entirety.

### TECHNICAL FIELD

In general, the disclosure relates to industrial production processes and to equipment that performs such processes. More particularly, the disclosure relates to computer systems, methods and computer-program products that support environmental surveillance of technical equipment such as ovens, by emission leakage diagnosis.

### BACKGROUND

In industry, reactors such as ovens perform industrial production processes. Much simplified, the processes can be continuous and uninterrupted processes, or the processes can be cyclic processes. A cycle usually starts when the oven takes in materials and ends when it outputs products. Ovens expose the materials to relatively high temperatures, and even for solid state materials, the processes involve substance that are gases. Some of the gases are useful by-products, and the gases are usually collected by gas collection pipes and the like.

Processes are described and controlled by parameters (or process variables), among them the temperatures of the materials and of the gas, as well as gas pressure, the quantity (materials, gas, auxiliary materials), the character of chemical reactions that occur at the materials, and many other parameters.

To keep parameters within pre-defined tolerance ranges, the ovens have sensors, actuators, controllers, and other equipment to implement control loops. Such control loops usually apply set-points, such as set-points for pressure, set-points for temperature and so on. Implementing control loops is well-known in the art. For example, a controller receives pressure data from at least one pressure sensor and interacts with a pressure valve to regulate the pressure to the set-point pressure.

Parameters may change during the execution of the process, for example, the gas pressure may drop or may rise. If such changes are desired (to support the process), the set-point usually varies over time.

Gas pressure within the oven is related to the air pressure outside the oven. As used herein, in case of “over-pressure”, the absolute pressure (of the process gas) inside the oven is higher than the absolute pressure (of the air) outside the oven. In case of “under-pressure”, the absolute pressure inside is lower than the absolute pressure outside.

Ovens have openings such as doors, holes, lids, connections, intake systems, offtake systems and so on. While the process is ongoing, the openings are usually closed, it is therefore convenient to use the term “closure” instead.

The main function of such closures is to charge material into the oven and to remove (processed) material from the oven. A closure-if properly closed-blocks any material movement through the closure. The occasions to open the closures are usually related to the process, and -simplified-a closure is open at the start and at the end of the process cycle, and otherwise-as the term suggests-it is closed.

Closures have the further function to prevent gas flow. Again simplified, process gas should not leave the oven in case of over-pressure (i.e., gas emission), and air should not go into the oven in case of under-pressure. The closures are typically equipped with sealings or the like to prevent gas emissions, but such sealings are exposed to the temperatures of the gases. The ability to stop gases decreases over time. Sealing conditions also deteriorate over time due to usage, for example, because they are frequently being opened and closed. On average, such a cycle may occur once a day. Leakages at the closures occur from time to time, and leakages have unwanted side-effects such as gas emissions.

Gas emissions have some aspects that need further attention: the gas may contain substances that could be deposited at or near the closures. Deposits (among them tar) are hardly removable, and deposits can deteriorate the sealings. Due to the chemical composition of the process gases, the process gases may be toxic or may be flammable. Air pollution is therefore a further concern, due to potential safety hazards to (human) operators, due to its environmental impact etc.

Human operators regularly look for emissions, for example, by visually inspecting the ovens and their closures. The operators estimate the intensity of emissions, the duration of the emissions, and other phenomena.

However, there is a variety of constraints: the operators apply special safety precautions (such as wearing protective clothing, wearing masks or the like) when approaching the ovens. The operators can not be present all of the time, so that the duration of the emissions is difficult to determine. Estimations by human operators do not have the accuracy of measurements with sensors, and the estimations may vary from operator to operator.

Further, the constraints are not limited to the operators, but also to the equipment that provides the control loops. Any modification in tolerance ranges, in the construction of the sensors, actuators, or even in the design of the closures creates the risk that the process may eventually fail or that equipment including the oven itself could be damaged.

US 2014/0002639 A1 discloses an approach to autonomously detect a chemical plume by evaluating images from a detection camera.

DE 10 2021 101 102 A1 discloses monitoring a coke-oven with an unmanned aerial vehicle. The UAV is able to measure the temperature by an IR-camera, to measure the gas concentration by chemical sensors, to take pictures of the oven by an on-board camera.

U.S. Pat. No. 10,059,884 B2 discloses a coke-oven and points out that the pressure inside the oven changes over time, and also refers to undesired emissions.

### SUMMARY

With the overall goal to reduce or even eliminate gas emissions from ovens to the environment through leakages, a computer interacts with one or more ovens at substantially one point only: the computer lets the controller of the oven update the pressure set-point. This set-point for the pressure inside the oven is updated to a particular value for that the emissions are expected to have a desired level that meets two conditions: (i) to avoid or to minimize emissions, but (ii) to let the process in the oven continue to perform efficiently.

The controller-implemented loop with data from pressure sensors is modified only by controlling the pressure set-point (of the controller). The method-performing computer can be considered as a further (or second) control loop to control an emission degree. The computer executes a (computer-implemented) method to obtain a pressure set-point for a controller that controls the gas pressure inside an oven.

Any area on the external surface of the oven where visible gas emissions can be present is referred to as leakage-area. From a camera that is external to the oven, the computer obtains a leakage-area image that shows the leakage-area. The computer processes the leakage-area image by a pre-trained network to classify a degree of emissions on the leakage-area image. The classification has several classes. In one embodiment, the network simply recognizes the presence of emissions (binary classes for presence and absence), in other embodiments, the network classifies the emissions at higher granularity.

The network has been trained from training data that comprises historical images that had been taken as reference. The human-made annotations are paired to the historical images.

Depending on the classified degree of the emissions, the computer applies pre-defined rules for changing the set-point.

In order to increase the accuracy to detect emissions, the image related activities (i.e., image obtaining and processing) can be performed in multiple instances.

A computer-implemented method is disclosed to obtain a pressure set-point for a programmable controller that is associated with an oven and that controls the gas pressure inside the oven. The programmable controller receives pressure data from at least one pressure sensor and interacts with a pressure valve.

From a camera that is located external to the oven (i.e., outside the oven), the computer obtains a leakage-area image that shows an area of the external surface of the oven where gas emissions can be present (i.e., may show up). In the following, this area is referred to as leakage-area.

The computer processes the leakage-area image by a pre-trained network to classify a degree of emissions on the leakage-area image. The network has been trained before from training data that comprise historical images that had been taken as reference and that comprise human-made degree annotations to the historical images. By applying pre-defined rules- and depending on the classified degree of the emissions-the computer changes the set-point for the programmable controller.

Optionally, the computer performs the step obtaining the leakage-area image from an optical camera so that the leakage-area image shows an area in that visible gas emissions can be present.

Optionally, the computer performs the step obtaining the leakage-area image from a thermographic camera so that the leakage-area image shows an area in that gas emissions can be present that are recognizable due to a temperature gradient to the background of the image.

Optionally, in the processing step, the computer uses the pre-trained network to classify the degree of emissions by a binary distinction into a first degree for absence of emissions and a second degree for presence of emissions.

Optionally, in the processing step, the computer uses the pre-trained network to classify the second degree into a plurality of sub-classes. The second degree can have the following sub-classes: presence as low emissions, presence as medium emissions, and presence as high emissions.

Optionally, the computer performs the steps obtaining the leakage-area image and processing the leakage-area image in multiple instances within a time-interval that is shorter than the time-interval it takes the controller-in interaction with the pressure valve-to actually change and stabilize the gas pressure to the set-point inside the oven.

Optionally, performing the steps in multiple instances, the computer performs obtaining the multiple leakage-area images, and the computer performs processing the multiple leakage-area images separately, to classify the degree for each instance separately, leading to multiple degrees in a degree vector.

Optionally, in applying the pre-defined rules, the computer evaluates the degree vector according to the distribution of the degrees within the degree vector.

Optionally, the computer evaluates the degree vector according to the distribution by any of the following: identifying the share between binary degrees for absence of emissions and presence of emissions, and identifying a change rate between degrees.

Optionally, in use for optical cameras, the computer further identifies the circumstances by that the camera has obtained the multiple leakage-area images. Such visibility circumstances are selected by any of the following: the quality of light to be natural light or to be artificial light, the absence or presence of precipitations in the scene between the camera and the oven, the absence or presence of dust at the objective of the camera. In applying the pre-defined rules with evaluating the degree vector, the computer adapts the pre-defined rules according to the circumstances.

Optionally, the computer identifies the circumstances indirectly by evaluating data that represents to environment of the camera, selected from the following: light intensity at the leakage-area, light property by differentiating day light from artificial light, light property by differentiating sun light from moon light, quality and quantity of precipitations that arrive at the oven, and detection of meteorological precipitations.

Optionally, the computer identifies the circumstances by processing the leakage-area images. For example, the computer can use a further network that has been trained for that purpose. That further network would identify rain, snow or other items between the oven and the camera. Simplified, the presence of such items indicates the circumstances deteriorate.

Optionally, the computer processes the leakage-area image by the pre-trained network that has been trained by any of the following: (1) from training data that comprise historical images that had been taken as reference from the oven, or (2) from training data that comprise historical images that had been taken as reference from a physically different oven.

Optionally, the computer obtains the leakage-area image(s) for multiple ovens of a battery. The camera is mounted on a vehicle that has the primary purpose to transport material to or from the multiple ovens. The vehicle moves with the camera.

A computer system is disclosed to obtain a pressure set-point for a programmable controller that is associated with an oven and that controls the gas pressure inside the oven. The programmable controller receives pressure data from at least one pressure sensor and interacts with a pressure valve. The computer system is adapted by comprising modules to perform the computer-implemented method.

The disclosure also relates to use of the computer-implemented method to obtain the pressure set-point to control the gas pressure inside an oven that is selected from the following: a coke oven, a furnace, an iron-making industry device, a piece of equipment for steel-making, a cement reactor, a concrete reactor, a chemical reactor.

A computer program (or a computer program product) is also disclosed. The computer program-when loaded into a memory of a computer and being executed by at least one processor of the computer-causes the computer to perform the steps of the computer-implemented method.

Further disclosed is a computer-implemented method to train a network to classify a degree of emissions (as explained, from leakage-area images of an oven by processing leakage-area images that show an area of the external surface of the oven where gas emissions are able to leave the oven). The computer connects historical images to the input of the network, and connects human-made annotations to the historical images at the output of the network. The human-made annotations comprise emission classes as the ground-truth. Connecting historical images comprises to change the pressure set-point of the oven by a particular pressure difference, until the oven emits camera-visible gases. The images that show the oven and the camera-visible gases are taken as historical images. Connecting human-made annotations (to the output of the network) comprises to use observations of particular emission degrees as annotations (or, optionally using the particular pressure difference as annotations).

From an overall perspective, the disclosure also relates to a computer-implemented method that can be seen as a combination of a first-to-be-executed method that involves training a network and of a second-to-be-executed method that involves using that trained network. Both methods can be executed by first and second computing functions, that are implemented by one physical computer or by two or more physical computers.

The second-to-be-executed method is used to obtain a pressure set-point for a programmable controller that is associated with an oven and that controls the gas pressure inside the oven. The programmable controller receives pressure data from at least one pressure sensor and interacts with a pressure valve. From a camera that is located external to the oven, the computer obtains a leakage-area image that shows an area of the external surface of the oven where gas emissions can be present, the leakage-area in the following.

The first-to-be-executed method is used to train a network to classify a degree of emissions on leakage-area images of an oven by processing the leakage-area images that show an area of the external surface of the oven where gas emissions are able to leave the oven (i.e., leakage-area). The first computing function connects historical images to the input of the network, and connects human-made annotations to the historical images at the output of the network, wherein the human-made annotations comprise emission classes as the ground-truth. The first-to-be-executed method results in a trained network to classify a degree of emissions on the leakage-area image (i.e., results in a network that is pre-trained).

The second computing function processes the leakage-area image by this trained network to classify a degree of emissions. By applying pre-defined rules and depending on the classified degree of the emissions, the second computing function changes the set-point for the programmable controller. Optional features are already outlined in this summary.

### BRIEF DESCRIPTION OF THE DRAWINGS

Embodiments of the present disclosure will now be described in detail with reference to the attached drawings, in which:

FIG. 1 illustrates an overview to phases and to image processing activities by networks applied to ovens in operation;

FIG. 2 illustrates an overview to control loops that are applied to ovens;

FIG. 3 illustrates a perspective view to an oven battery, as well as illustrates a plurality of set-point control loops;

FIG. 4 illustrates a single oven, a closure of that oven, and visible emissions at a leakage-area, and also introduces emission degrees;

FIG. 5 illustrates a training phase with a neural network being trained;

FIG. 6 illustrates the two control loops applied to a single oven, with controllers as well as a camera and a pre-trained network;

FIG. 7 illustrates a flow-chart diagram of a computer-implemented method to obtain a pressure set-point for a programmable controller that is associated with an oven;

FIG. 8 illustrates a flow-chart diagram for an approach in that some steps of the method of FIG. 7 are performed in multiple instances;

FIG. 9 illustrates images in various situations to describe further approaches to increase the classification accuracy; and

FIG. 10 illustrates a generic computer for use to perform any of the methods.

### DETAILED DESCRIPTION OF DRAWINGS

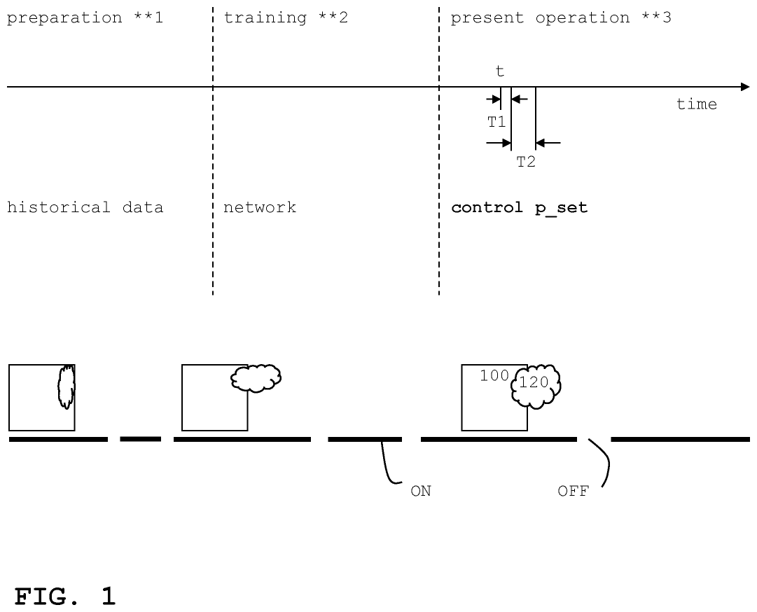

FIG. 1 illustrates an overview to phases **1, **2, and **3 that are related to image processing activities. A network applies image processing to one or more ovens 100 in operation.

From a general point of view, the description focusses on computer-implemented image processing by networks. The networks apply machine-learning techniques that involve training. The images may show (or may not show) gas emissions 120 from one or more ovens 100. With the overall goal to reduce (and-if possible-to eliminate) gas emissions (from the ovens to the environment through leakages), the description describes an approach to detect gas emissions at present time (that means during the operation of the oven).

The identification of counter-measures is contemplated, such as changing the pressure inside the ovens.

To explain the network, the description differentiates phases, and FIG. 1 illustrates an overview to
preparation phase **1, during that data is collected for use by one or more networks,
training phase **2, during that the collected data serves to train the networks (i.e., to become trained networks), and
present operation phase **3, during that the one or more trained networks serve to control the operation of the oven.

The oven can be in operation “ON” during all phases.

Image processing by networks can be followed by measures. There can be immediate measures such as adapting the operation of the oven at present (such as to change the pressure, in real-time).

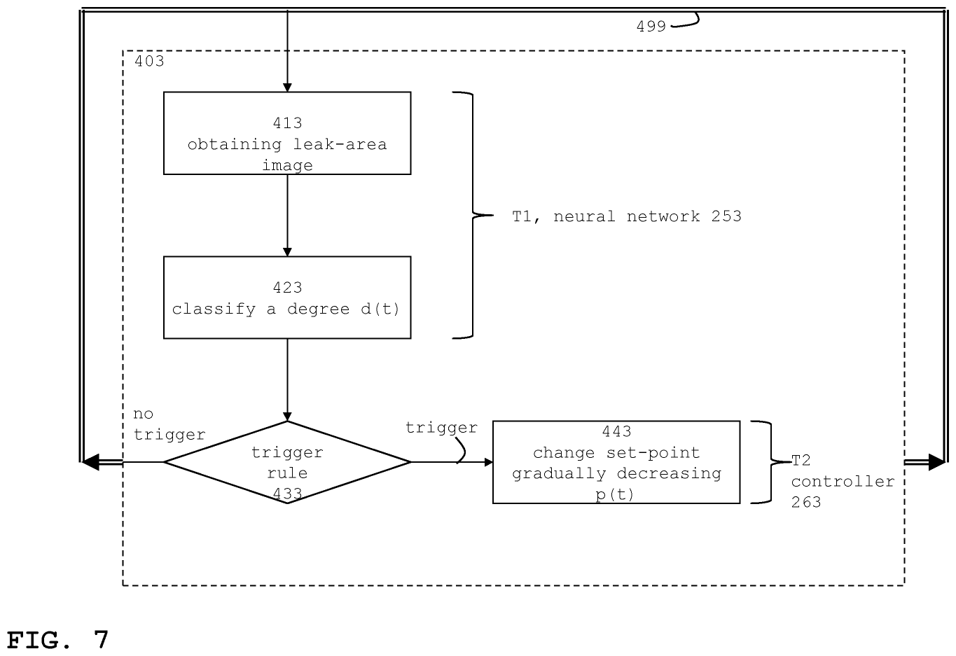

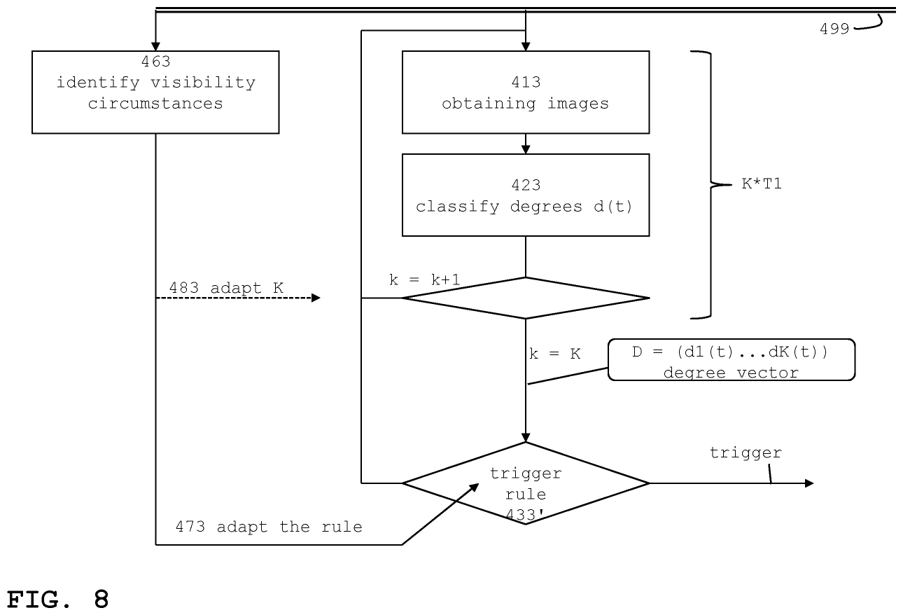

A computer-implemented method is performed during the present operation phase **3 to obtain (or modify) a pressure set-point “p_set” for a programmable controller that controls the gas pressure inside the oven. Details will be explained as method 403 with FIGS. 7-8. The method is executed while one or more ovens are in a processing state in that leakages are ideally not expected (e.g., when closures are closed). It can be expected that the computer executes the method in repetitions so that emissions-should they occur-are immediately detected (cf. FIGS. 7-8).

Time interval T1 stands for the time it takes the computer to execute a step sequence to obtain data that describe emissions (such as to classify the emissions). The step sequence comprises obtaining (one or more image), and classifying the (one or more) images.

Time interval T2 stands for the time it takes a programmable controller (acting on other components of the ovens) to apply countermeasures until the emissions have stopped. The duration of T2 mainly depends on the processes inside the ovens, and time-interval T2 comprises
the time to move pressure valves (i.e., to open or to close them) and
the time to let the pressure change (to a new pressure set-point) and to stabilize the pressure (at the new set-point) inside the ovens.

T2 refers to a single oven. In case that multiple ovens operate in parallel, T2 is expected to be the similar for all ovens.

Time-interval T2 follows time-interval T1 with a relatively short interval-the so-called trigger interval-by that the computer applies pre-defined rules to evaluate the emission classification and to eventually trigger the controller (optionally via an auxiliary controller) to change the pressure set-point. The duration of the trigger interval can be neglected here.

It is noted that T1 is shorter than T2. This effect of this disbalance in time can be advantageously applied by the method optionally. Much simplified, the time interval T1 (cf. FIG. 7) can be estimated in terms of seconds and the time interval T2 in terms of minutes.

The description notes the present time-point by “t”. Unless stated otherwise, t points to the time when the method starts to be executed (cf. method 403 with start line 499 in FIG. 7). As the emissions are not expected to start or to stop within T1, the notation t applies for the time-interval T1 as a whole (i.e., trough the end of method execution).

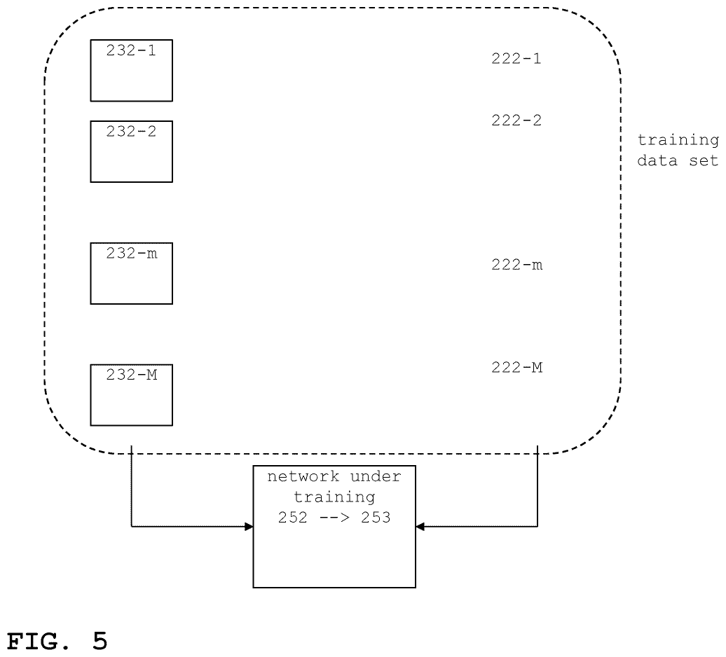

Collecting historical data (regarding emissions) and annotating them is performed in preparation phase **1. The training phase **2 requires training one or more networks (network 252 to network 253, FIG. 5). The training phase **2 can start as soon as a sufficient amount of training data has been collected (and annotated).

The present operation phase **3 comprises the run-time of the computer that performs methods, such as method 403 to be explained with FIGS. 7-8.

During the present operation phase **3, the one or more ovens change the emission behavior that can be measured in terms of larger intervals, such as T2.

FIG. 1 shows the operation of the oven over time by a bold horizontal line. The line is not scaled but has some gaps to symbolize that the oven is not under pressure all of the time. As emissions are expected during “pressure ON time” only, collecting data for use by networks (in phase **1) is therefore much limited to “pressure ON”. Further, the network serves to control the operation of the oven (in phase **3) during “pressure ON” only. Training the network (phase **2) is independent from the operation of the oven so it can be performed during ON and OFF.

As data regarding the ON/OFF state is available at any time, the description does not further discuss that and assumes that the method is performed during “pressure ON” only.

Data that represents emission intensity is given by degrees (or classes). Although degrees are not the same as exact measurements, the accuracy (and granularity) is sufficient to identify measures against emissions, such as changing the pressure set-point.

The description will close with discussing details, for example regarding implementation details for cameras, for image pre-processing and so on.

### Control Loops

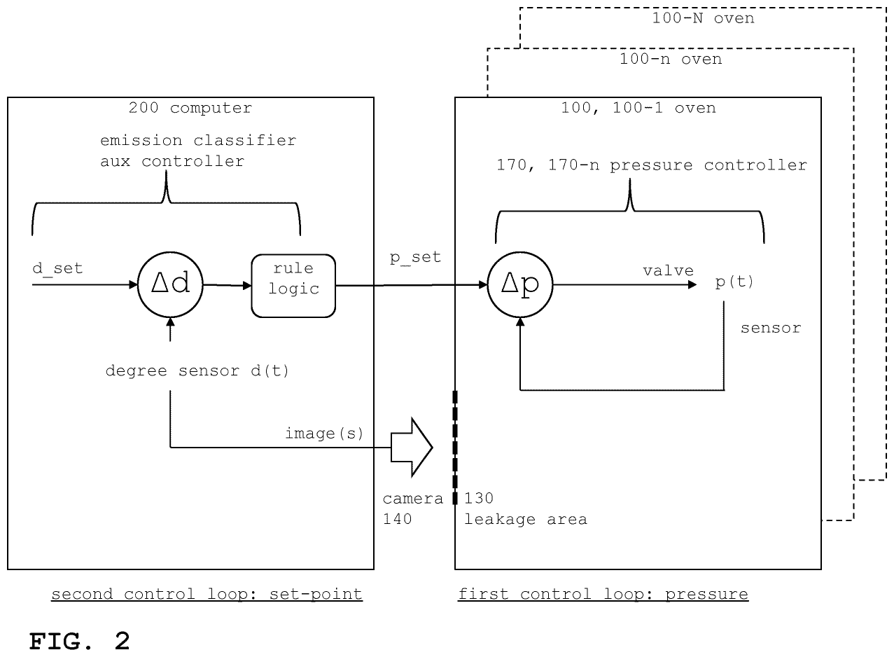

FIG. 2 illustrates-much simplified-an overview to first and second control loops that are applied to oven 100. Both loops interact to reduce the gas emissions from oven 100 to the environment through leakages.

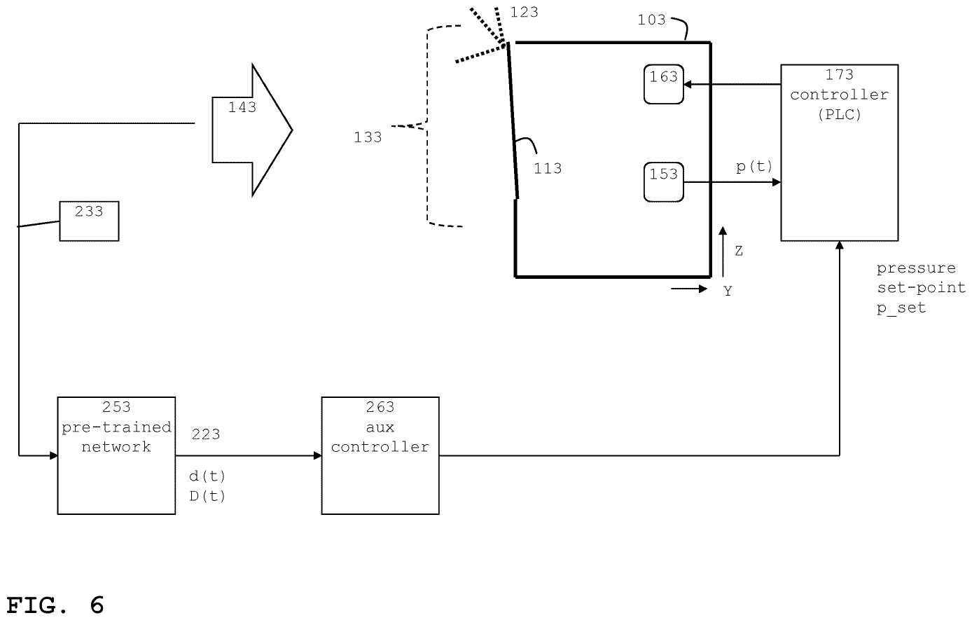

As illustrated on the right side of the figure, pressure controller 170 implements a first control loop to control the pressure p(t) inside oven 100. Pressure controller 170 receives pressure data p(t) from at least one pressure sensor and interacts with a pressure valve (cf. FIG. 6 for details). Depending on the difference Ap between the actual value p(t) and the set-point p_set, pressure controller 170 opens or closes the valve. As used herein, the term “pressure valve” comprises equipment that allows to change the pressure inside the oven, directly or indirectly.

When the temperature inside oven 100 changes, the pressure p(t) changes as well, but pressure controller 170 keeps the pressure at the set-point p_set.

As illustrated on the left side of FIG. 2, computer 200 (in the functions of an emission classifier and of an auxiliary controller) implements a second control loop.

The second control loop adapts the set-point (p_set) of the first control loop, but with a different input: the emission degree. Computer 200 executes a (computer-implemented) method to obtain the pressure set-point p_set for controller 170 that controls the gas pressure inside oven 100 (cf. first control loop, method in FIG. 7).

The second control loop has a set-point in a desired minimal emission degree (d_set, e.g., no emissions, or low emissions). From a high-level perspective, computer 200 implements several functions:
(i) Computer 200 acts as an emission degree sensor to obtain d(t). This function is implemented by a module called “emission classifier”, during T1).
(ii) Computer 200 also acts as a comparator to generate a trigger, depending on the deviation Δd in the degree d(t) to d_set, during the negligible short trigger interval.
(iii) Computer 200 also acts as set-point generator that-once the trigger has been generated-processes further parameter data (from the oven) and generates a new pressure set-point (or confirms the old one). In other words, the set-point generator applies a rule logic to update p_set. The further parameters are, for example, the temperature, information regarding the process in the oven to indicate if a pressure change would be allowable for that particular process, etc. The rule logic may simply automate the reaction of the operators when they become aware of emissions (to reduce the pressure by certain amounts).

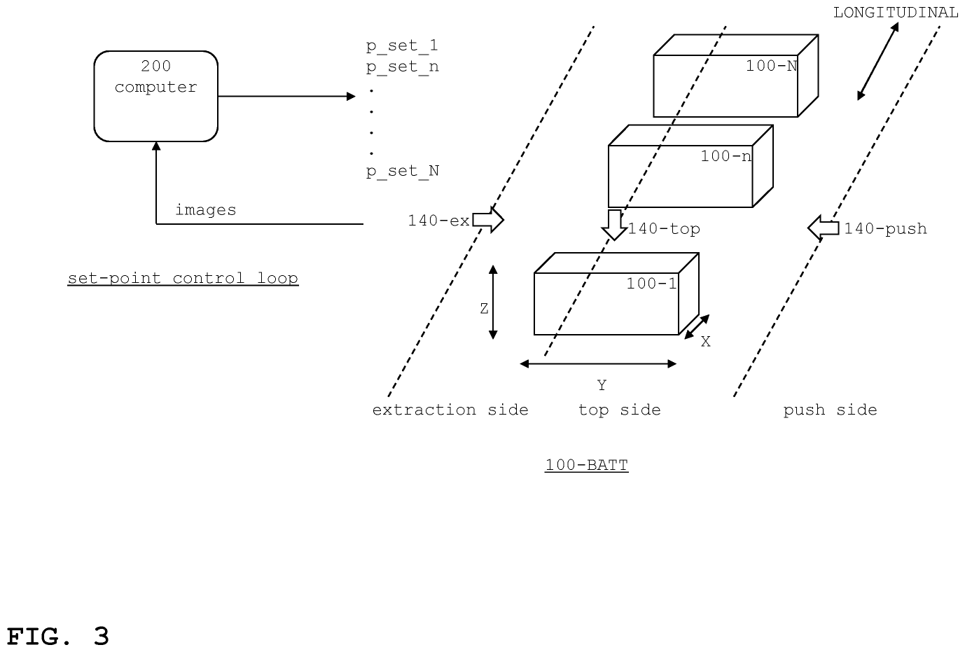

With details to be explained, computer 200 implements the emission degree sensor by using a neural network (or an equivalent machine-learning tool) to process images taken by one or more cameras 140 from one or more leakage-areas 130 (of oven 100). The description will symbolize one ore more cameras by arrows pointing to the leakage-areas, cf. for example FIGS. 3 and 6.

The other functions (ii) trigger generator and (iii) set-point generator can be implemented by an auxiliary controller.

It is noted that both control loops “touch” in one point only: the second control loop provides p_set (for example by updating). The feedback from oven 100 to computer 200 goes from the image over the network (as emission classifier) and over the rule logic.

Skilled persons have been implementing (first) control loops for oven pressure over centuries (or even longer). In theory there is even no need to apply sophisticated electronics or the like. The first control loop could even be implemented by mechanics only.

For the second control loop and especially for its degree sensing function (i), the picture is completely different: It requires to take images from particular areas of the oven (such as from leakage-area 130), to pre-process the images (such as by receiving human annotations, phase **1), to train a network (phase **2), to run the trained network (phase **3) and so on.

It is convenient to explain the second loop by referring to coke ovens being prominent examples for ovens. Based on the description herein, the skilled person can apply the teachings to other ovens (or to reactors in general).

### Camera and Visibility

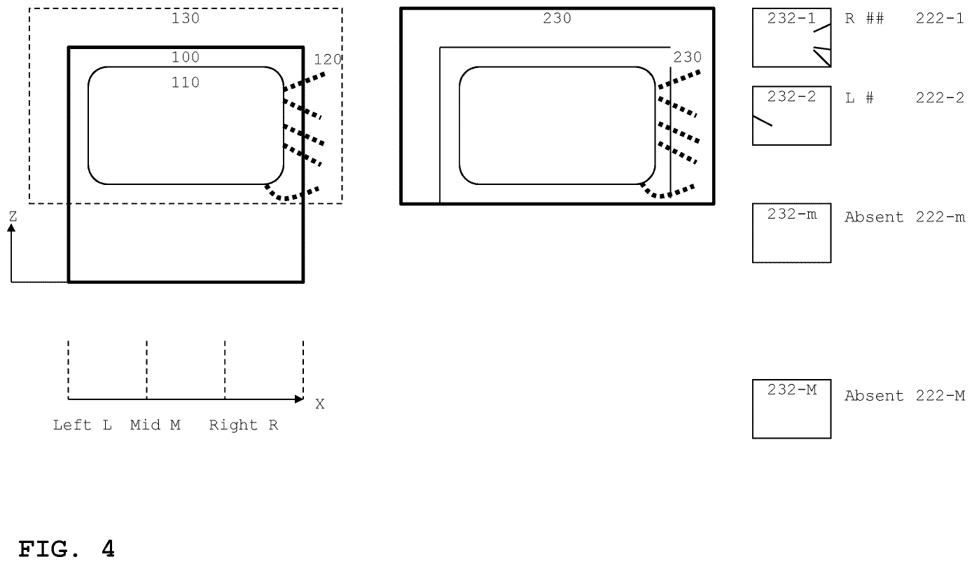

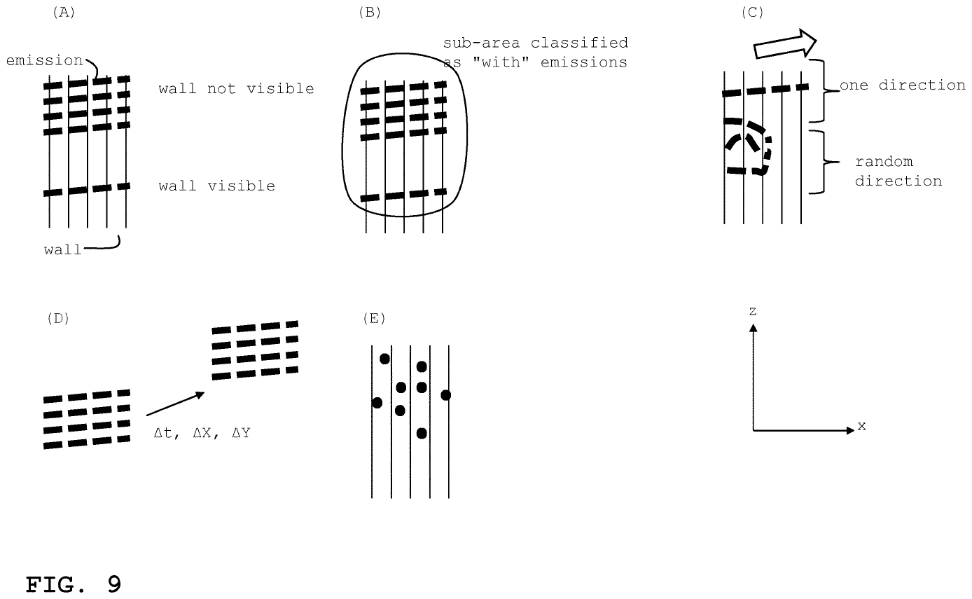

From a high-level perspective, images represent properties of leakage-area 130 by data. Data in individual pixels correspond to properties of individual locations on leakage-area 130, and the description explains some examples in FIGS. 4 and 9.

As cameras-especially digital cameras that take images-are well known in the art, the skilled person can align the camera to leakage-area 130, can select the appropriate optics (i.e., the lens system), can select sensors with appropriate technology (e.g., charge-coupled devices CCD, complementary metal-oxide-semiconductor CMOS, or other technologies), can make the camera mechanically robust for industrial environments (i.e., to withstand vibrations, dust, humidity and the like), can implement the transmission of image data from the camera to the computer (e.g., via networks for use in industry), and so on.

Just to illustrate this approach by way of example, the skilled person uses so-called industrial cameras, and may equip such cameras with dust-protection (i.e., by covers), or some dust removal functions (similar to windscreen wipers). The cameras would be remote-controlled (i.e., manual exposure is not required). Such cameras are also available as surveillance cameras, and potentially an existing surveillance camera can operate as camera 140 as well.

The description does not have to explain such camera details, but in view of human involvement, the following is noted.

Although computer displays are omnipresent in industrial settings, the images do not have to be shown to a human user (such as the operator of the oven), at least on the majority of situations (i.e., not during phase **3).

In other words, the drawings here in this application occasionally symbolize images by showing objects on the leakage-area, among them doors with or without emissions, but in real implementations, the images are processed by computer 200.

As a consequence, camera 140 can be implemented by a camera to operate in either of two wavelength ranges:
(i) Camera 140 that operates in a first radiation range would be an optical camera taking images from visible light (i.e., approximately between 380 and 750 nano meters). Usually, the light at the camera is reflected light. Usually, the sensors in optical cameras are optimized to provide images for display to humans, and the sensors are implemented as RGB-sensors or as sensors that apply other color schemes.
(ii) Camera 140 that operates in a second radiation range would be thermographic camera taking images from infrared radiation. Infrared radiation is emitted from the leakage-area 130 itself. An oven door would be distinguished from its environment because in operation it is relatively hot. Emissions would be distinguished from the doors due to temperature differences that can be captured by thermographic cameras. The IR-spectrum is relatively large, and convenient wavelengths are in the range from 8 to 14 μm. Usually, the sensors in thermographic cameras are optimized to provide data that represents temperature per pixels.

On images taken by thermographic camera, gas emissions are recognizable due to a temperature gradient to the background of the image. The temperature gradient does not have to be measured, but it is expected that the gas emissions would have a temperature that is higher than the surface of the oven (appearing as background). Temperature differences are estimated to be in the range between 50 Kelvin and 400 Kelvin.

As used herein, emissions are understood to be “camera-visible”, for both radiation ranges. Emissions are “visible” for both human eyes and for optical cameras (i.e., first range), and emissions are “thermo-visible” for thermographic cameras (but not for human eyes).

With details to be explained, the images are being linked to human annotations during preparation phase **1. The annotations become the ground truth for training, in phase **2. In phase **1, images taken by optical cameras would be shown to the expert on computer displays, but images taken by thermographic cameras would be shown on displays in an adapted way. For example, individual temperature values could be shown by different colors, in a so-called heat-map.

The assignment of colors to temperatures would have to be such that the expert can differentiate emissions from the rest of the image. In other words, if the expert can't see emissions on an (heat-map) adapted image, he can't annotate any emission degrees or the like.

An hybrid approach can address this constraint: images to be annotated can be taken by two cameras in two versions. A thermographic camera would be aligned to an optical camera so that both cameras would see the same leakage-area at substantially the same point in time.

The optical-camera version (by the optical camera) would be shown to the expert (in phase **1), the training data for phase **2 would comprise the annotations in combination with the images in the thermographic camera version.

### Hybrid Approach

It can be expected that processing images from thermographic cameras in the second control loop (with emission classification) is less accurate than processing images from optical cameras.

However, this potential disadvantage can be compensated if the thermographic camera serves in a back-up function. Ovens emit heat all the time-day and night and thermographic cameras can provide images (that show the leakage-areas) all the time. In contrast, the optical cameras would provide images at night (or other “poor” conditions or circumstances) only if the ovens would be lit by artificial light (the energy consumption would not to be neglected). (The exception for a fire from the oven at night is not discussed here, but such a fire would not be an emission to be regulated by the pressure set-point.) Operating the second control loop (in phase **3) can therefore be differentiated, depending on the light conditions (i.e., visibility circumstances to be outlined below, FIG. 8) into
with the optical camera only,
with both cameras in parallel, and selecting the most reliable degree data thermographic camera only (in backup scenarios, when the optical camera can't provide images)

### Multiple Ovens in a Battery, Coke Oven As the Prominent Example

FIG. 3 illustrates a perspective view to battery 100-BATT of ovens 100-1, 100-n, 100-N as well as illustrates a plurality of oven-specific set-point control loops. Ovens can be arranged in parallel, in batteries (with oven 100-n “touching” oven 100-(n+1), the ovens located adjacently) or otherwise. Some of the controlling equipment (such as controller computers, user interfaces etc.) can be applied for the battery (usually to control individual ovens separately).

The ovens could be coke ovens. Taking the example of coke ovens is convenient also for the following: coke ovens are usually installed in such batteries, and a single battery 100-BATT may have N ovens 100-n. Typical values vary from N=30 for some batteries to N=75 for other batteries.

While there would be oven-specific controllers 170-n (cf. FIG. 2), and oven-specific set-points p_set_n, computer 200 can be implemented as a single computer that multiplexes its operations to provide oven-specific set-points. FIG. 3 symbolizes computer 200 receiving images from cameras (arrow symbols), and providing set-points as a vector (p_set_1, ..., p_set_n, ..., p_set_N) with values for ovens 100-1, 100-n, 100-N individually. Multiplexing (i.e., serial execution) is just given by way of example, the skilled person can process multiple loops with multiple set points otherwise, for example, by processing in parallel (or in hybrid approaches involving parallel and serial processing).

FIG. 3 also introduces coordinate conventions, again by way of example only. Individual ovens 100-n have a width X (usually equal for all N ovens) and ovens 100-n are arranged in longitudinal direction. Individual ovens 100-n have a length Y, and a height Z. Taking the material into account, Y is differentiated into a “push side” and an “extraction side”. It can be assumed that X, Y and Z are substantially equal for all n=1 to N.

The camera symbols point to areas (“leakage-areas”) where gas emissions may occur: camera 140-ex may take images from the XZ-plane at the “extraction” side of the battery (here illustrated on the left side), camera 140-top may take images from the XY-plane at the top of the battery, and camera 140-push may take images from the XZ-plane of the “push” side of the battery.

In a battery, the ovens with their doors usually look alike, and pre-processing images can be applied to harmonize images. For example, the ovens may have numbers painted on their surfaces, but these painted numbers have not influence to emissions. As the numbers would show up on the images, pre-processing could remove them from the images.

Or, for example, in case that standardized elements of the oven (such as door hinges) would show up in the images in mirrored view, the images could be pre-processed to have the hinge arrangement harmonized.

Leakage-areas do not have to correspond to the XZ- or XY-planes completely, it is rather expected that every oven in the battery has one or more areas where leakages are expected (leakage-areas), for example, at the mentioned closures. Occasionally, leakage may occur where heating walls and material chambers touch with each other.

Leakage-areas can be differentiated by areas that belong to individual ovens (index n) and can be differentiated by the parts that belong to each oven. For example, for ovens that have doors at both sides, there would be extraction-side and push-side leakage-areas.

The dashed lines indicate trajectories for cameras that are (optionally) implemented by cameras that can move:
extraction-side trajectory (line on the left side),
top-side trajectory, and
push-side trajectory.

There is a simplification: in order to cover broad areas, a single camera may move over multiple trajectories. For example, camera 140-top may start monitoring areas at oven 100-1 at the push side, move to oven 100-N, and return to monitor from oven 100-N to oven 100-1 at the extraction side.

The cameras do not have to move along linear trajectories, they could also be installed at fixed positions and could point to particular leakage-areas by camera movements (e.g., tilting, panning).

Images taken by the camera are associated with meta-data indicating the time-point when an image was taken, the identification of the oven (cf. by index n or the like), the identification of the leakage-area (cf. extraction side, top side, push side). Using coordinates with finer granularity is possible, with FIG. 4 showing an example.

Coke ovens are known in the art for decades, and the process in the coke oven is a distillation process. While coke is the main product, the gas is a by-product (raw coke oven gas). The patent literature is full of overview drawings and there is even in IPC class: C10B DESTRUCTIVE DISTILLATION OF CARBONACEOUS MATERIALS FOR PRODUCTION OF GAS, COKE, TAR OR SIMILAR MATERIALS.

For example, FIG. 1 of EP 1 065 254 B1 (document '254 in the following) shows a perspective view of such a battery with coke ovens. Individual ovens are made from carbonization chambers and combustion chambers, and there are closures/openings: such as charging holes (or lids) for charging material from the top, doors disposed on each end of the carbonization chambers (to push the coke). The reference also shows vehicles (or “cars”) and defines a longitudinal direction (that FIG. 3 repeats here).

A paper by Ghosh et al. shows an overview in its FIG. 1 as well (N. K. GHOSH and L. PARTHASARATHY “Atmospheric Pollution Control in Coke Ovens. ”Clean Technologies for Metallurgical Industries (EWM-2002), 24-25 January, 2002, National Metallurgical Laboratory (CSIR), Jamshedpur).

Although the terminology may by different from reference to reference, gas leakages may occur at closures (or openings) such as doors (XZ-planes, push and extraction), charge holes (charging/charge holes/lids, XY-plane at the top), ascension pipes (cf. Ghosh et al, at the top).

The gas pressure drops during the distillation process (from a relatively high to a relatively low value). The relative gas pressure (i.e., overpressure) is set to a set-point p_set having a pre-defined value. For example, the set-point can be given as relative pressure with respect to the atmosphere, and such a set-point could be between 50 Pa and 200 Pa. Written in an alternative unit, this would be approximately between 5 and 20 millimeters of water. The gas pressure is adjusted (first loop in combination with the second loop) to minimize gas emissions through the doors when the distillation process starts, and to minimize air intake through the doors when the distillation process ends. In other words, the set-point may vary in correspondence to the process.

Substances produced by gas emissions may turn into above-mentioned tar depositions (when cooled down). These depositions are difficult to remove from surfaces, and they shorten the lifecycle of the doors.

### Control Loops

Having mentioned some basic concepts for ovens (and for coke ovens serving as example), the description now provides details for the control loops in an overview to one oven 100.

The description may differentiate components being active during the above-mentioned phases **1, **2, and **3. In other words, throughout this description, references noted as **1/**2/**3 stand for components that are similar but that are different in these phases. References **0 (as in FIGS. 2-4) do not need to differentiate the phases. This convention does not imply that all components are required in all phases: for example, network 253 (FIG. 6) is only required during operation **3.

The description differentiates the phases in view of the neural network by that computer 200 (cf. FIG. 2) provides the emission degree d(t). From that perspective, training occurs in phase ** 2. Preparation phase **1 is the phase in that images and observations are collected over time to obtain a training set for the network (cf. FIG. 5, historical data). Training phase **2 is the phase in that the network is being trained, and operation phase **3 is the phase in that trained network is being used to be part of the second control loop.

FIG. 4 illustrates oven 100, closure 110, visible emissions 120 (i.e., camera-visible emissions) as well as introduces emission degrees d(t). The figure repeats the coordinates Z and X. Coordinate X is conveniently further divided into “left”, “mid”, and “right”, but that simplified scale is just convenient for explanation.

On its left side, FIG. 4 illustrates oven 100 (such as, for example, a coke oven that belongs to a battery, cf. FIG. 3), with closure 110. In the example, closure 110 is a door in the XZ-plane (i.e., at the extraction side or at the push side of an oven battery). But it does not matter where closure 110 is located at oven 100, during operation it should remain closed.

However, there are camera-visible emissions 120, such as the emission of gas from oven 100. The figure symbolizes the emissions by bold dashed lines. Emissions may occur in leakage-areas 130 (or better: occur from leakage-areas). In the example, leakage-area 130 is shown to include the door and to include the part at the top of oven 100.

As already introduced, the term “leakage-area” stands for any area on the external surface of the oven where camera-visible gas emissions can be present. The following further differentiation of the leakage-area is useful to make:
(i) The external surface of the oven where emissions can leak, such as at the perimeter of a closure, can be labeled “emission origin” area.
(ii) The external surface of the oven where emissions-after having been leaked would still be visible, can be labeled “emission distribution” area.

For convenience of explanation, it can be assumed that-simplified-the “emission origin” and the “emission distribution” areas are disjunct. Computer-vision techniques could differentiate them (if properly trained, cf. FIG. 9 for a discussion), and the inherent property of the emissions to move away from their origin (emissions are fugitive) can be used to determine to have emissions.

As leakages are rather exceptions to be prevented, leakage-areas could be attributed to be “potential leakage-areas”. But for simplicity of explanation, the description uses the label “leakage-areas” only.

In the example, emissions 120 should occur in the right part (X-coordinate with letter R) of leakage-area 130 near the door. (The figure is simplified in not further differentiating origin and distribution areas). Simplified, it can be assumed that emissions 120 are camera-visible where they occur.

On its center part, FIG. 4 illustrates leakage-area image 230, showing the door (at least partially) and showing emissions 230. The reference changes from 120 to 230 because the emissions are on the image. The figure is simplified here in that images capturing is showed for ideal situations, substantially all emissions would be camera-visible in the image. The description will discuss accuracy (for non-ideal situations) below with FIG. 8 (and partially with FIG. 9).

On its right side, FIG. 4 illustrates a collection of images 232-1, 232-2, 232-m, 232-M. The images had been taken during preparation phase **1 (as historical data) and had been annotated during that phase **1. Annotations 222-1, 222-2, 222-m and 222-M are human-made annotations, here given in the notation R, L, M (corresponding to the X-coordinates), and “absence of emissions” or “presence of emissions”. The # symbols further differentiate presences as “# presence as low emissions”, “## presence as medium emissions”, and “### presence as high emissions”.

Annotating the images by two main categories (absence, presences) and by sub-categories (low, medium, high for presence) is just convenient for illustrations. The number of categories correspond to the number of categories the network in operation (253 in FIG. 6) will be able to differentiate.

The collection of leakage-area images 232-m with annotations 222-m serve as training data (cf. the reference written as **2, details in FIG. 5).

Inspection procedures are usually standardized. For example, the United States Environmental Protection Agency (EPA) has defined an air pollution test method to determine the visible emissions (VE) from coke ovens (“Method 303—By-product Coke Oven Batteries”). For Europe, a convenient reference is provided by the Umweltbundesamt (German Federal Environment Agency) as the “Merkblatt über die besten verfügbaren Techniken in der Eisen- und Stahlerzeugung nach der Industrie-Emissionen-Richtlinie 2010/75/EU, März 2012 [Directive 2010/75/EU of the European Parliament and of the Council of 24 Nov. 2010 on industrial emissions]”. The document refers to method 303 as well. Ghosh at al. mention further standards.

It is noted that the result of such inspections can be used as annotations. The annotating expert may not have to look at images, but images to be annotated should be captured by cameras during inspection. The skilled person can apply data-binding techniques to relate particular annotations to particular images. For example, the expert inspects a particular oven, enters a particular emission degree (and other data) into a database, and makes sure that a camera takes an image. It is however not required that the expert looks at this image again.

It is further noted that image 232-m and annotations 222-m do not have to be made for a particular oven for that the network operates during phase **3.

Within a battery (cf. 100-BATT in FIG. 3), the ovens look almost identical. Each oven may have individual labels (such as identification numbers), and occasionally, the name of the company that runs (or made) the battery may be written on surfaces as well. Between batteries, the style of such labels or name plates may be different.

Such relatively minor differences in the external view of an oven (or battery) do not influence the emissions. The annotating expert (in phase **1) would ignore such differences.

In order to avoid overfitting during subsequent training (phase **2) it is possible to harmonize the locations with individual labels (or the like) by image pre-processing. For example, numbers—if visible on an image—could be removed.

### Training

FIG. 5 illustrates the training phase **2 by neural network 252 that is being trained to become neural network 253. The annotations serve as the ground truth.

It is in the expertise of the skilled person to validate the network once training has been completed. Details regarding validation are therefore omitted for simplicity.

### Obtaining Further Training Data

Every time an emission is detected during operation (i.e., in phase **3), such emissions can be classified (by the operators) and can be linked to images taken during operation. Such annotated images 232-m/222-m could be used for follow-up training (i.e., new instances of phase **2). Over time, the accuracy of emission detection would rise.

It can happen that for a particular battery, training data (cf. FIG. 5 image 232-m/222-m) is not yet available in sufficient quantities so that the network could classify the degrees. It is contemplated for use an initially trained network (training based on historical data from other batteries) and to continuously re-train the network (if available with historical data from the oven for that network 253 is being applied).

Emissions (to be used in the training data) may occur only from time to time. That can be expected for relatively new batteries and/or for ovens with relatively new doors. New door sealings would prevent emissions better than old door sealings.

From the view of operation (in phase **3) this is beneficial. To collect less historical data for training (phases **1 and **2) might be less optimal to develop the network (by trainings). In other words, the lack of battery-specific training data prevents the network to sharpen its accuracy for this particular battery.

But there is simple approach by that training data can be enhanced. For batteries 100-BATT with individual pressure control (for each oven 100-n, cf. FIG. 3), pressure can be changed-at least temporarily-until emissions show up (least camera-visible emission). Images would show the emissions. Annotating does not have to rely on the images: the experts do not have to look at images, because the experts already know that emissions occur. The pressure difference that leads to such purpose-created sample emissions are known. Data that describes the pressure difference could serve as an emission degree, but it is noted that individual ovens may show different emission degrees for equal pressure difference.

### Two Control Loops

FIG. 6 illustrates the two control loops (of FIG. 2) applied to a single oven 103, with controllers 173 and 263 as well as camera 143 and pre-trained network 253. The layout of FIG. 5 is similar to the layout of FIGS. 2-3, with the set-point control loop on the left side and with the pressure control loop on the right sight. As the figure illustrates the oven during operation, it uses references ** 3.

Pre-trained network 253 and auxiliary controller 263 can be implemented by computer 200 (cf. FIGS. 2-3). Network 253 implements the emission classifier (cf. above-mentioned function (i)), and controller 263 implements the trigger generator and the set-point generator (functions (ii) and (iii)).

Oven 103 is illustrated with door 113 (being an example for a closure) in a side-view looking to the YZ-plane. Oven 103 is much simplified, by showing a single door only. (In terms of FIG. 3, this corresponds to the doors at both sides).

Oven 103 has pressure sensor 153 that provides a numerical value that represents the inside pressure inside p(t), at any time point t. Programmable controller 173 (or “programmable logic controller PLC”) receives pressure set-point p_set. Programmable controller 173 instructs pressure valve 163 to increase or to decrease the pressure in oven 103. Arrangements with sensor 153, programmable controller 173 and valve 163 are known in the art.

In embodiments, controller 173 does not receive set point p_set all the time from controller 263, but only when emissions are detected (i.e., when a trigger has been generated).

Any system that allows changing the pressure would correspond to valve 163. The skilled person can select the system that fits best. To name only one example, systems to control the pressure independently in each oven of a coke battery are commercially available from Paul Wurth S. A. (32, rue d′Alsace, L-1122 Luxembourg, LUXEMBOURG) under the trademark SOPRECO. Simplified, such systems are part of the discharge pipes, and discharge orifices are varied to control the gas flow rate through the pipes. Details are explained, for example, in EP 2 160 449 B1.

Gas emissions 123 leave the oven 103 through leakages (of the closed door or otherwise), and it is expected that emissions 123 occur mainly in leakage-area 133 at the external surface of oven 103. A minor fraction of the emissions may also leave through other areas, but for classifying the degree that is not relevant. Emissions 123 are camera-visible (cf. the section “Camera and visibility”).

As camera 143 captures image 233 from area 133, most of the emissions would be shown on the image (at least data would represent emissions). The figure illustrates a single camera, but as discussed with FIG. 3, other cameras could be place to other leakage-areas (cf. cameras 140-ex, 140-top. 140-push).

Image 233 arrives at pretrained network 253 substantially at the same time when it was taken (i.e., at time-point t). Signal propagation delay on its way from camera 143 can be neglected. Of course, image 233 arrives without any annotations. Pre-trained network 253 provides degree d(t), with the categories or classes introduced above (cf. FIGS. 3 and 4). Regarding accuracy it is noted that ideally the degrees would be the same that a human expert would determine. (The description provides an example to achieve higher accuracy, by using vector D(t) instead of d(t), cf. FIG. 8).

Simplified, auxiliary controller 263 processes d(t) and provides a new set-pressure point (if needed). Instead of receiving d(t), controller 263 can receive a trigger, cf. FIG. 7. Optionally, controller 263 can be implemented by a-pre-trained neural network as well.

FIG. 6 is simplified by not illustrating meta-data, and for using the approach with multiple ovens (such as for a battery), the skilled person can use data binding and other techniques to ensure that p_set is applied to the oven from that the image was taken. In other words, data binding ensures to have p_set_n, that images are related to particular oven index n, and so on.

As explained already, programmable controller 173 (cf. FIG. 6) receives pressure data p(t) from at least one pressure sensor 153 and interacts with pressure valve 163. The pressure is thereby maintained to a pressure set-point p_set. Controller 173 is active when oven 103 is under pressure (cf. ON in FIG. 1).

FIG. 7 illustrates a flow-chart diagram of computer-implemented method 403 to obtain a pressure set-point p_set for programmable controller 173 that is associated with oven 103 and that controls the gas pressure p inside oven 103.

The figure presents method 403 within a dashed rectangle. Double-lines indicate that the execution of method 403 would be repeated periodically (during ON, cf. FIG. 1).

Method 403 is illustrated with a single start at line 499. Each method execution starts at time-points that in FIG. 1 are named “time-point t”. Method 403 is illustrated with two alternative ends. On the right side, method 403 ends by step 443 changing the set-point p_set for programmable controller 173. In many situations, the new set-point would be selected such that the pressure decreases gradually. Having a new set-point may however comprise to keep p_set unchanged.

On the left side, method 403 is repeated in case that the detected emission degree is below pre-defined thresholds (or other discriminators) so that step 443 is not required. Or in other words, method 403 ends with the follow-up activities (step 443) if a trigger has been generated, or ends when no trigger has been generated.

As mentioned, when method 403 has ended, it will be repeated (from point 499) again. In view of computation efficiency, there can be a waiting time (from end at 433/443 to start 499). The waiting time can be related to T2.

FIG. 7 illustrates method 403 for a single oven, but method 403 can be performed for the N ovens in batteries (cf. battery 100-BATT), in serial repetitions (in parallel, or in combinations thereof, cf. FIG. 3 as outlined for computer 200). Method 403 can be multiplexed for the ovens of a battery (cf. FIG. 3), and the execution time T1 of step sequence 413/423 to obtain the classification (function (i)) would still be sufficiently short.

Camera 143 that is located external to the oven 103 obtains (step 413) leakage-area image 233. Image 233 shows an area 130, 133 of the external surfaces of the oven 100, 103 where camera-visible gas emissions 120, 123 can be present. As explained, area 130, 133 is the leakage-area.

The computer-with emission classifier by neural network 253—processes (step 423) leakage-area image 233 by pre-trained network 253 to classify degree 223 (or d(t), cf. FIG. 6) of emissions 123 on the leakage-area image 233.

As explained with FIG. 5, network 253 has been trained from training data 232-m, 222-m that comprise historical images 232-m that had been taken as reference and that comprise human-made degree annotations 222-m paired to the historical images 232-m.

Step sequence 413/423 is executed during T1 (cf. FIG. 1).

By applying pre-defined rules in step 433 and depending on classified degree 223 (d(t)) of visible emissions 123, the computer changes (step 443) the set-point (p_set) for programmable controller 173. As illustrated in FIG. 6, this set-point changes can be implemented outside the network, in controller 263.

In the example, the (new) set-point is set such that the pressure p(t) in oven 103 can gradually decrease.

### Pre-Defined Rules

Generating the trigger does not have to cause a set-point adaptations in all situations. The skilled person is able to implement the first control loop (cf. the right side of FIG. 2) with further dimensions. The rules applied in step 433 can comprise to process further data. For convenience, the following is mentioned by way of example:
Depending on the process conditions within the oven, changing the pressure could be allowed or blocked. When the process is ending-when the doors are to be opened in temporal proximity-re-setting the pressure might be not desired.
There could be a pre-defined limitation in the number of set-point changes (and consequently actions involving the pressure valves). Such limitations may be in force to load or operate the valve not more than needed.
Rules may be set up to with optimization goals, such as to keep energy consumption low.

The skilled person can apply further step 433 rules, without the need of further explanation herein. It is however noted that the accuracy of rule input data-such as the correspondence of the degree from step 423 to any alternative measurement (such as by visual inspection)-does influence the outcome of the rules.

### Becoming More Accurate

Having explained method 403 in the context of the control loops for one or more ovens in FIG. 7, the description now discusses optional approaches to change the pressure set-point with more precision. These optional approaches require to obtain the degree (in step 423) with higher accuracy.

The approaches will be explained with FIG. 8 (multiple step instances, rule adaptations) and FIG. 9 (oven-specific classification).

### Multiple Step Instances

FIG. 8 illustrates a flow-chart diagram for an approach in that steps 413 and 423 of method 403 of FIG. 7 are performed in multiple instances.

As already explained for method 403, obtaining the leakage-area image 233 (cf. FIG. 6) in step 413 and processing that image in step 423 leads to a classification by degree d(t).

But for each execution of both steps 413 and 423, there are at least two conflicting constraints, in view of
classification accuracy, and
computation resource spending.

Looking at the classification accuracy constraint, the computer would provide classifications that does not match the reality in all situations. Ideally operating computers that correctly classify the images for all situations are not available.

Taking any binary classification as an example, with P for presence (of emissions) and A (for absence of emissions), in multiple executions of method step 413 and 423 the computer would output
true positives (output is P in correspondence to presence in reality of the oven),
false positives (output is P, but in contrast to absence in reality),
true negatives (output A, in correspondence to absence in reality), and
false negatives (output A, but presence in reality).

As explained, the classifications (cf. the left side of FIG. 7 at step 423) may trigger a change of the set-point (cf. trigger and step 433 at the right side of FIG. 7).

Consequently, false classifications might lead to an incorrect change of the set-point. In a worse case scenario, the oven would operate correctly without emissions, but it might start emitting substances because the pressure is set wrong.

Looking at the computation constraint, images capturing and image processing can be improved to increase the classification accuracy (e.g., to increase the share of “true” over the share of “false”). However, such improvement would require, for example,
more sophisticated cameras (such as in terms of pixel numbers),
suitable light conditions at any time,
a relatively high amount of training images (that might not be available, at least not initially), and
more computing resources (in terms of CPU, memory consumption etc.).

The solution to overcome the constraints takes different time intervals into account: performing method step 413 and 423 (time interval T1) requires less time than gradually decreasing the pressure (time interval T2). Flowcharts in such figures are not scaled to time, but nevertheless, method 403 as illustrated in FIG. 7 shows a time disbalance.

### K Instances

The execution of steps 413 and 423 can be performed in K instances. In other words, there can be K detection cycles (with steps 413 and 423). FIG. 8 symbolizes such multiple performances with a counter k and a counter check (for example, counter k=1 to K). Performing K instances serially by repeating the step execution is convenient because the overall method executing time K*T1 would still be less than T2.

It would also be possible to perform K instances in parallel (even with different cameras).

Executing step 413 and 423 in K instances leads to a degree vector D(t)=(d1(t), d2(t), d3(t), ..., dk(t), ..., dK(t)) with K degrees dk(t). FIG. 6 illustrates D(t) next to d(t) as being degree 223.

In case of serial execution, there would be K different time-points, but all time points would be within repetition interval K*T1. The time-points could therefore be summarized to a single “t” standing for the interval between the first performance (k=1) and the last step performance (k=K).

As a result, the degree vector D(t) serves as the basis to determine if the trigger (to change the set-point) has to be applied (cf. FIG. 7). Having a degree vector D(t) (with K elements) instead of a single degree d(t) increases the accuracy. Of course, some of K elements are “false” classifications (or in other granularities, classification that are incorrect otherwise). Occasionally, for some instances, degree might not even be available.

The evaluation (to set the trigger) is performed by applying trigger rule in step 433′. Step 433′ in FIG. 8 is an enhanced version of step 433 (FIG. 7), but the consequence (to generate the trigger or not) are the same.

The trigger rules in step 433′ are pre-defined. Just to give an illustrative example, for the binary classification, the trigger could be set if the majority of the K degree values is P (present). For example, the K=10 vector D(t)=(P, P, P, A, A, P, P, P, A, P) has more P than A, and the trigger would be set. (If the pressure set-point is changed or not, is decided in step 433, FIG. 7).

The trigger rules in step 433′ can be learned by a tool that applies machine learning (such as by a neural network or the like). Training would be performed accordingly.

For example, steps 413 and 423 should be repeated for K=100, so that vector D(t) would have 100 elements dk(t). T1 should be about 3 seconds (for capturing the image, transmitting the image to the computer, processing etc.), and the overall time K*T1 would be 3*100 seconds (or 5 minutes). The seconds and minutes are given for illustration only.

As the reaction time (between changing the set-point of the control loop and having the emission stopped) is assumed to be equal or larger than K*T1, is does not matter if the set-point is modified a couple of minutes earlier or later.

For example, the computer could apply a rule to generate the trigger if at least J =50 (of the K=100 vector elements) are “P” (emissions are present).

This example with thresholds based on the J/K share is much simplified. Other rules (or further rules) are possible as well. For example, if J=20 consecutive degrees from dk(t) to d(k+19)(t) would be “P”, the trigger could be generated as well.

### Trigger Rule Adaptation

Using K instances still has the constraint that the accuracy of individual degrees d(t) that belong to vector D(t) is not improved. But the trigger rule (in step 433′) has an accuracy as well. As the accuracy also depends on visibility circumstances (i.e., the camera being directed to leakage-area 130), the rule can be made dependent on visibility.

As used herein, the term “visibility” stands for the quality by that leakage-area image 230 corresponds to the reality at leakage-area 130. Visibility can be detected and represented by data. For this embodiment, visibility is the visibility by optical cameras.

The skilled person can apply sensor or the like to collect data that describe visibility circumstances, for examples according to the following:
At night, the optical camera has to rely on artificial light (light from lanterns, flash light during exposure etc.), during the day, the camera takes the images from natural light.
Day-light conditions vary. Precipitations like rain or snowfall darken the scene (between the camera and the oven). The sky could be cloudy or not.
Rain or snow, dust and the like may hit the objective of the optical camera and the image may be corrupted.

As illustrated, by step 463, the computer identifies visibility circumstances. As illustrated by line 473, the computer uses that visibility circumstances to modify the trigger rule.

The visibility circumstances modify the conditions by that the trigger rule generates the trigger (to change the set-point).

The computer can aggregate these and other visibility circumstances to a visibility score. For convenience of explanation, the score should be a real number between 0 and 1, from “no visibility at all” to “best conditions”. In case of zero, the method execution would fail because the images would be black.

For simplicity of explanation, the visibility score-although determined by the computer—can be differentiated into “good visibility” and “poor visibility”.

To stay with the above K=100 example, for “good visibility”, it would be sufficient to generate the trigger if J=30 (of the K=100 vector elements) are “P” (emissions are present), for “poor visibility”, the trigger would have to set if J=70 (again out of 100) are “P”.

### Further Aspects of Trigger Rule Adaptation

The following discussion for rule adaptation does not have to differentiate the cameras, the discussion applies to optical cameras and to thermographic cameras.

Ovens are being operated during decades, and it can be expected that some ovens are in operation for more than 40 years, or even more than 60 years. Simplified, older ovens suffer from emissions more than younger ovens. The elapsed operation time can optionally be used as a modifier for the rules.

In connection with FIG. 7, the description has already mentioned that rule 443 (to change the set-point) can process further data. Likewise, further data could be used in the trigger rules as well. For example, the probability to have emissions may depend on the process phases. An oven that starts a new process may be more likely to “smoke” than an oven in that process is about to end (i.e., the coke would be ready soon).

### Repetition Adaptation

Adapting the rule can be accompanied by adapting the repetition rate K (i.e., the number of instances, the instance cardinality), as symbolized by line 483. For example, poor visibility would demand for more repetitions (relatively high K), and good visibility would allow less repetitions (relatively low K).

### Oven-Specific Classification

FIG. 9 illustrates leakage-area images (A), (B) ... (E) in symbolic views that show further aspects that neural network 253 can optionally apply to obtain the classification. Visible emissions show certain behavior (visible for optical cameras), and the neural network could by trained to such behavior. Training network 252 to become network 253 has been explained with FIG. 5 and additional or alternative features could be trained to the network as well, via annotations, or non-supervised. In other words, the models that are explained next could be implemented by network 252/253.

It is contemplated to train a semantic segmentation model to classify areas inside the images.
For example, the symbolic illustrations show bold dashed lines for emissions (as in (A), (B)). This leads to image areas showing emissions.
For example, the symbolic illustrations differentiate the walls or other external elements of the oven, given here by thin vertical lines (as in (A), (B), (C). As the walls do not move, they do not move on the images either. With multiple images in the training set, the network learns where the walls are located, even if some images show the walls covered by emissions.

Semantic segmentation could also differentiate the leakage-area into emission origin and emission distribution areas, not only by semantic segmentation but also by approaches that are explained next.

Semantic segmentation can identify directions by that visible emissions are “arranged”. View (C) shows emissions in a line that is slightly increasing and shows emissions that are somehow turbulent (rather random direction, caused by weather influence, etc.).

It is contemplated to process multiple images taken from consecutive points in time. As explained already, there is sufficient time (T1<T2) available (within T2). As the emissions would usually move, and as the wall etc. do not move, moving elements on the image could be identified, by a properly trained network. In the example, view (D) shows emissions moving, with a temporal aspect (during At) and with a spatial aspect (displacement Ax, Az in pixels, corresponding to locations at the oven, cf. the coordinates in FIG. 4). In other words, speed can be detected.

It is contemplated to process multiple images taken from consecutive point in time not only in view of speed but also in view of speed changes.

On the way from the origin, emissions loose density. Density could be estimated letting the network learn to see the walls through the “cloud”, as in (A). Some wall structures (e.g., the door itself, the door frame, buckstays or beams) would be “strong candidates” for where emissions could be expected.

Movements (in terms of speed or speed change) are not equal over the image (cf. the density lost or the like), and it is possible to let the network derive images that look like histograms. On the way from the origin, emissions no only loose density but also loose speed. Such phenomena would be identifiable from derived images as well.

Method to evaluates images are known in the art, as optical flow detection or the like, with discussions in the following:
Dileep K. Appana, Rashedul Islam, Sheraz A. Khan, Jong-Myon Kim: A video-based smoke detection using smoke flow pattern and spatial-temporal energy analyses for alarm systems (Information Sciences, volumes 418-419, December 2017, Pages 91-101; doi.org/ 10.1016/j.ins.2017.08.001).
Jinkyu Ryu and Dongkurl Kwak: A Study on a Complex Flame and Smoke Detection Method Using Computer Vision Detection and Convolutional Neural Network, 2022 (Fire 2022, 5, 108K; mdpi.com/ 2571-6255/5/4/108).

Performing advanced image processing (such as explained here with FIG. 9) is further enabled by the available time. As explained, the computer has a sufficiently large time interval available (smaller than T2) to potentially perform K instances during K*T1.

Performing advanced image processing can be regarded as a further embodiment to perform steps 433 or 433′ (cf. FIGS. 7-8).

As ovens are not necessarily located under roofs, precipitations such as snow could appear on the images as well, cf. symbol (E). However, snow falls from the clouds and would move in top-down direction (here in coordinate z), potentially in some wind-related further directions (x). It is contemplated to train the network to detect such precipitation.

The detection of such or similar events could potentially lead to the following:
to perform the detection of precipitations as step 463 “identify conditions” with the consequence to modify the rules (as explained with FIG. 8) and/or to change the number of instances K,
to stop the interaction with controller 173 (so that the pressure set-point is not changed) to avoid incorrect operation of the oven,
to inform the operator that changing the set-point according to emissions is temporarily disabled.

### Further details

The description now investigates details that may apply in general.

FIG. 3 illustrates a battery with multiple ovens, and with trajectories to move the cameras. The above-mentioned document '254 shows a battery with more details, such as with a coal-charging car that moves on the top portion of the coke oven (cf. the top trajectory in FIG. 3), and with guide cars (or vehicles in general) at the extraction side and the push sides (cf. the trajectories on both sides). Although the cars have the primary function to move material in and out the oven, the cars could be used in a secondary function to carry cameras (such as cameras 140-ex, 140-top-140-push or others).

Using existing cars (or vehicles) may be advantageous because the cars are controlled to reach a particular oven. In other words, existing intra-battery navigation can be re-used in a synergistic way.

Classifying images to emission degrees is not the same as-for example recognizing numbers or letters.

Historical images 232-m can be collected under different light conditions: with sunshine, at night, on rainy days and so on. As the sun moves, the images are taken at different times of the day.

As explained, historical images 232-m are applied (if annotated) to train network 252 (cf. FIG. 5) to enable the network to perform method 403. The same images—if annotated accordingly—can be used to train network 272.

In case that oven elements (such as doors) have different external views, for example, if the doors look differently at the extraction side and at the push side of the battery (cf. FIG. 3), the degree classification can be made more accurate by using two sets of historical images (for each side separately).

Activities such as installing cameras 140 and computer 200, as well as running method 403 do not substantially interfere with the operation of the oven(s). As explained already, the only additional activity is allowing controller 173 to receive set-point p_set.

The skilled person is familiar with automation layers. Installing computer 200 as a so-called level 2 automation module is possible.

In comparison to inspections by humans, executing method 403 is possible whenever the one or more ovens are operative (i.e., during ON in FIG. 1). This helps to monitor emissions continuously. The approach may also reduce the number of inspections by humans, so that the health-related risks for the inspectors are reduced.

Taking further data into account is convenient: some doors will be recognized to suffer from emissions more than other doors, and the doors can be categorized accordingly. The above-mentioned rules—such as trigger rule 433/433′—can be adapted in step 473 by taking door categories into account.

In the scenario in that the set-point is changed until the oven emits gases, the magnitude of the pressure difference (before and after the change) in relation to the emission degree (detected by steps 413, 423 or otherwise by inspection) is a quality indicator for a particular oven. When the same pressure difference is applied, some doors are more likely to leak than others. Such indicators can be taken as a further input for step 473 as well.

### Generic Computer

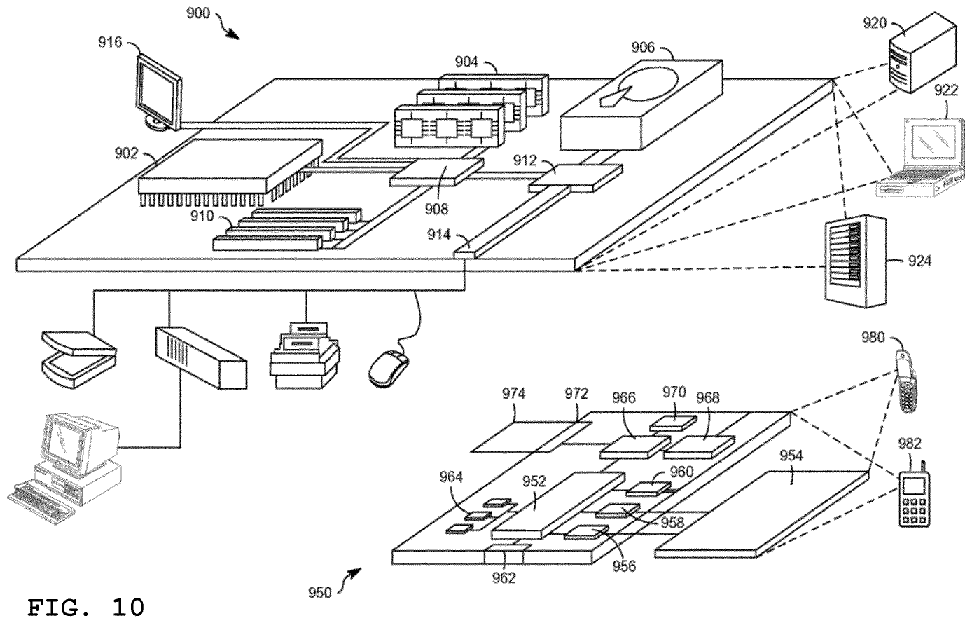

FIG. 10 illustrates an example of a generic computer device which may be used with the techniques described here. FIG. 10 is a diagram that shows an example of a generic computer device 900 and a generic mobile computer device 950, which may be used with the techniques described here. Computing device 900 is intended to represent various forms of digital computers, such as laptops, desktops, workstations, personal digital assistants, servers, blade servers, mainframes, and other appropriate computers. Generic computer device may 900 correspond to the computer system 200 of FIG. 3. Computing device 950 is intended to represent various forms of mobile devices, such as personal digital assistants, cellular telephones, smart phones, driving assistance systems or board computers of vehicles and other similar computing devices. For example, computing device 950 may be used as a frontend by a user (e.g., an operator of a blast furnace) to interact with the computing device 900. The components shown here, their connections and relationships, and their functions, are meant to be exemplary only, and are not meant to limit implementations of the disclosures described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer-or machine-readable medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 984 may also be provided and connected to device 950 through expansion interface 982, which may include, for example, a SIMM (Single In Line Memory Module) card interface. Such expansion memory 984 may provide extra storage space for device 950, or may also store applications or other information for device 950. Specifically, expansion memory 984 may include instructions to carry out or supplement the processes described above, and may include secure information also. Thus, for example, expansion memory 984 may act as a security module for device 950, and may be programmed with instructions that permit secure use of device 950. In addition, secure applications may be provided via the SIMM cards, along with additional information, such as placing the identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer-or machine-readable medium, such as the memory 964, expansion memory 984, or memory on processor 952 that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 980 may provide additional navigation-and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing device that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing device can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the disclosure.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. A computer-implemented method to obtain a pressure set-point for a programmable controller that is associated with an oven and that controls the gas pressure inside the oven, wherein the programmable controller receives pressure data from at least one pressure sensor and interacts with a pressure valve, the method including the steps of:
from a camera that is located external to the oven obtaining a leakage-area image that shows an area of the external surface of the oven where gas emissions can be present, referred to as the leakage-area in the following;
processing the leakage-area image by a pre-trained network to classify a degree of emissions on the leakage-area image, wherein the network has been trained from training data that comprise historical images that had been taken as reference and that comprise human-made degree annotations paired to the historical images; and
by applying pre-defined rules, and depending on the classified degree of the emissions, changing the set-point for the programmable controller.

2. The method according to claim 1, wherein the step of obtaining the leakage-area image is performed by obtaining the leakage-area image from an optical camera so that the leakage-area image shows an area in that visible gas emissions can be present.

3. The method according to claim 1, wherein the step of obtaining the leakage-area image is performed by obtaining the leakage-area image from a thermographic camera so that the leakage-area image shows an area in that gas emissions can be present that are recognizable due to a temperature gradient to the background of the leakage-area image.

4. The method according to claim 1, wherein in the processing step, the pre-trained network classifies the degree of emissions by a binary distinction into a first degree for absence of emissions and a second degree for presence of emissions.

5. The method according to claim 4, wherein in the processing step, the pre-trained network classifies the second degree into a plurality of sub-classes.

6. The method according to claim 5, wherein in the processing step, the pre-trained network classifies the second degree into one of the following sub-classes: presence as low emissions, presence as medium emissions, and presence as high emissions.

7. The method according to claim 1, wherein performing the steps obtaining the leakage-area image and processing the leakage-area image is performed in multiple instances within a time-interval that is shorter than the time-interval it takes the controller in interaction with the pressure valve to actually change and stabilize the gas pressure to the set-point inside the oven.

8. The method according to claim 7, wherein by performing steps in multiple instances,
steps obtaining are performed to obtain multiple leakage-area images, and
steps processing are performed for the multiple leakage-area images separately, to classify the degree for each instance separately, leading to multiple degrees in a degree vector.

9. The method according to claim 8, wherein applying the pre-defined rules comprises evaluating the degree vector according to the distribution of the degrees within the degree vector

10. The method according to claim 9, wherein evaluating the degree vector according to the distribution comprises any of the following: identifying the share between binary degrees for absence of emissions and presence of emissions, and identifying a change rate between degrees.

11. The method according to claim 1, in use for optical cameras, further comprising identifying circumstances by that the camera has obtained the multiple leakage-area images, referred to as visibility circumstances hereinafter, wherein the circumstances are selected from any of the following:
the quality of light to be natural light or to be artificial light,
the absence or presence of precipitations in the scene between the camera and the oven, and
the absence or presence of dust at the objective of the camera; and
wherein applying the pre-defined rules with evaluating the degree vector is performed with adapting the pre-defined rules according to the visibility circumstances.

12. The method according to claim 11, wherein the visibility circumstances are identified indirectly by evaluating data that represents to environment of the camera, selected from the following:
light intensity at the leakage-area,
light property by differentiating day light from artificial light,
light property by differentiating sun light from moon light,
quality and quantity of precipitations that arrive at the oven, and
detection of meteorological precipitations.

13. The method according to claim 11, wherein the visibility circumstances are identified by processing the leakage-area images.

14. The method according to claim 1, wherein processing the leakage-area image by the pre-trained network is performed by a network that has been trained by any of the following: from training data that comprise historical images that had been taken as reference from the oven, or from training data that comprise historical images that had been taken as reference from a physically different oven.

15. The method according to claim 1, wherein obtaining the leakage-area image is performed for multiple ovens of a battery wherein the camera is mounted on a vehicle that has the primary purpose to transport material to or from the multiple ovens, and wherein the vehicle moves with the camera.

16. A computer system to obtain a pressure set-point for a programmable controller that is associated with an oven and that controls the gas pressure inside the oven, wherein the programmable controller receives pressure data from at least one pressure sensor and interacts with a pressure valve, the computer system being adapted by comprising modules to perform a computer-implemented method according to claim 1.

17. The computer-implemented method according to claim 1, wherein the pressure set-point to control the gas pressure inside an oven is obtained and is selected from the following: a coke oven, a furnace, an iron-making industry device, a piece of equipment for steel-making, a cement reactor, a concrete reactor, a chemical reactor.

18. A computer program product that-when loaded into a memory of a computer and being executed by at least one processor of the computer causes the computer to perform the steps of the method according to claim 1.

19. A computer-implemented method to train a network to classify a degree of emissions on leakage-area images of an oven by processing leakage-area images that show an area of the external surface of the oven where gas emissions are able to leave the oven, the method including the following steps:
connecting historical images to the input of the network that are obtained by changing the pressure set-point of the oven by a pressure difference, until the oven emits camera-visible gases, taking images that show the oven and that show the camera-visible gases as historical images; and
connecting human-made annotations to the historical images at the output of the network, wherein the human-made annotations comprise emission classes as the ground-truth obtained by using observations of emission degrees.
